(19) United States
(12) Patent Application Publication
(10) Pub. No.: US 2001/0051694 A1
(43) Pub. Date: Dec. 13, 2001

(54) POLYURETHANE CRYSTALLINE THERMOPLASTIC AND METHOD FOR THE PRODUCTION THEREOF

(76) Inventors: JOAQUIM JULIA BARGES, ALELLA (ES); JOSE LUIS AYUSO PIQUERAS, BARCELONA (ES)

Correspondence Address: LEOPOLD PRESSER, SCULLY SCOTT MURPHY & PRESSER, 400 GARDEN CITY PLAZA, GARDEN CITY, NY, 11530

(21) Appl. No.: 09/341,804

(22) PCT Filed: Nov. 18, 1998
(86) PCT No.: PCT/ES98/00313

§ 371 Date: None

(30) Foreign Application Priority Data
Nov. 20, 1997 (ES) 9702425

(51) Int. Cl. C08G 18/00; C08G 18/42

(52) U.S. Cl. 525/440; 528/80

(57) ABSTRACT

The compound has the general formula I

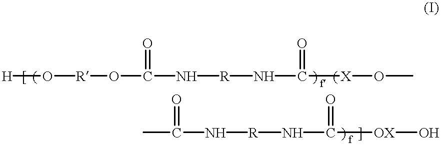

(1<f<500;1<f′ 15;R and R′ are alkyl or aryl) and X has the formula II

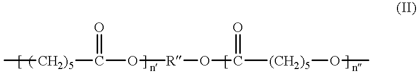

(2<n<140;1<(n+n′)<51). The method comprises reacting a polyether-polycaprolactone block copolymer having a molecular weight ranging from 1,000 to 6,000 and having formula IIa

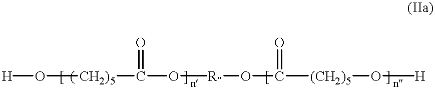

with a chain extender of formula HO—R′—OH and with a diisocyanate of formula OCN—R—NCO.

### DESCRIPTION

The invention relates to a crystalline polyurethane thermoplastic material having the general formula I

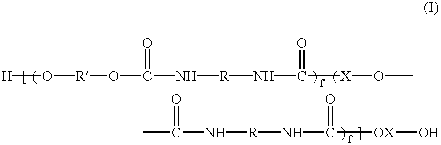

where f is an integer ranging from 1 to 58; f′ is an integer ranging from 0 to 58; R and R′ are the same or different and stand for alkyl or aryl groups and X is a polycaprolactone block polymer, having a molecular weight ranging from 500 to 25,000 and having formula II

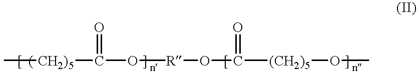

where R″ is an alkyl or aryl group, and n′ and n″ are integers the sum of which ranges from 42 to 220.

This polyurethane is particularly useful in thermobonding and hot melt applications in the industrial markets, above all for footwear, wood and automation.

The polyurethane thermoplastic materials of the present invention have the advantage over all the known polyurethane thermoplastic materials of being very crystalline, with good physico-chemical and mechanical properties, and at the same time very thermoplastic, with softening points of 60-70° C. and very soluble in all the regularly used solvents. They are also very easily presentable in microbead form or convertible into powders.

The invention also relates to a method of preparing the said compound. This method is characterised in that it comprises reacting a polycaprolactone polymer of relatively high molecular weight

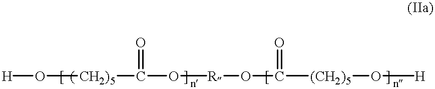

with a diisocyanate of formula OCN—R—NCO and optionally with a chain extender of formula HO—R′—OH, where R and R′ have the same meaning as indicated hereinbefore. Said extender is preferably 1,4-butanediol and said diisocyanate is diphenylmethane 4,4′-diisocyanate, toluene 2,4- and 2,6-diisocyanate, dicyclo hexylmethane 4,4′-diisocyanate or 3-isocyanomethyl-3,5,5-trimethylcyclohexyl isocyanate.

The reaction is also preferably conducted by mixing equimolecular amounts of diisocyanate with the formula II polycaprolactone polymer.

It is contemplated that mixing be continuous with a flow rate ranging from 200 to 1200 kg/h of total component weight, in an extruder, at a temperature ranging from 150° to 350° C. and with a mean dwell time ranging from 45 seconds to 2.5 minutes.

The reaction is preferably conducted in the presence of metal complex based catalysts proper to urethane reactions, particularly tin and/or bismuth derivatives.

### EXAMPLE 1

Preparation of a crystalline polyurethane thermoplastic material

87.0 kg of 2,4; 2,6 toluene diisocyanate and 5,000 kg of the polycaprolactone polymer were used. These products were mixed in a continuous process at a rate of 600 kg/h in a double screw extruder of a form proper to a reactor, at a temperature held to between 200° and 300° C. and with a mean dwell time ranging from 1.5 to 2.0 minutes.

On exiting from the extruder, the product was cut, cooled and formed into beads, was dried and packaged under standard temperature and humidity conditions. An amount of 100 ppm of metal complex catalysts was used in the process.

### EXAMPLE 2

Preparation of a crystalline polyurethane thermoplastic material

250 kg of 4,4′-diphenyl-methane diisocyanate and 10,000 kg of the polycaprolactone polymer were used. These products were mixed in a continuous process at a rate of 600 kg/h in a double screw extruder of a form proper to a reactor, at a temperature held to between 200° and 300° C. and with a mean dwell time ranging from 1.5 to 2.0 minutes.

On exiting from the extruder, the product was cut, cooled and formed into beads, was dried and packaged under standard temperature and humidity conditions. An amount of 100 ppm of metal complex catalysts was used in the process.

1. A crystalline polyurethane thermoplastic material having the general formula I 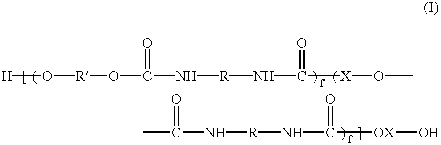
where f is an integer ranging from 1 to 58; f′ is an integer ranging from 0 to 58; R and R′ are the same or different and stand for alkyl or aryl groups and X has the formula II 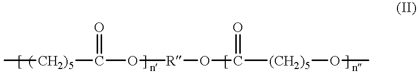
where R″ is an alkyl or aryl group, and n′ and n″ are integers the sum of which ranges from 42 to 220:

2. A method for the preparation of a crystalline polyurethane thermoplastic material of general formula I 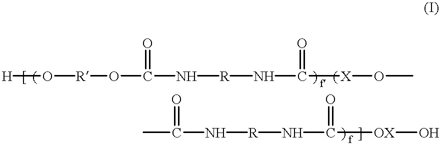
where f is an integer ranging from 1 to 58; f′ is an integer ranging from 0 to 58; R and R′ are the same or different and stand for alkyl or aryl groups and X has formula II 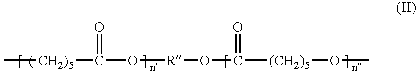
where R″ is an alkyl or aryl group, and n′ and n″ are integers the sum of which ranges from 42 to 220, characterised in that it comprises reacting a polycaprolactone polymer of formula IIa 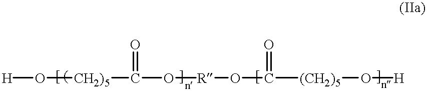
where R″, n′ and n″ have the meaning given hereinbefore, with a diisocyanate of formula OCN—R—NCO where R and R′ have the meaning given hereinbefore.

3. The method according to claim 2, characterised in that a chain extender of formula HO—R—OH is used in said reaction between the polycaprolactone polymer of formula IIa and said diisocyanate.

4. The method according to claim 3, characterised in that said extender is 1,4-butanediol.

5. The method according to at least one of claims 2 to 4, characterised in that said diisocyanate is diphenylmethane 4,4′-diisocyanate, toluene 2,4- and 2,6-diisocyanate, dicyclo hexylmethane 4,4′-diisocyanate or 3-isocyanomethyl-3,5,5-trimethylcyclohexyl isocyanate.

6. The method according to one of claims 2 to 5, characterised in that said reaction is conducted by mixing equimolecular amounts of diisocyanate with said chain extender and said polycaprolactone polymer of formula II, said last two compounds being present at a molar rate ranging from 0/1 to 1/1 respectively.

7. The method according to claim 6, characterised in that the mixing is continuous with a flow rate ranging from 200 to 1200 kg/h of total component weight, and is performed in an extruder, at a temperature ranging from 150° to 350° C. and with a mean dwell time ranging from 45 seconds to 2.5 minutes.

8. The method according to one of claims 2 to 7, characterised in that said reaction is conducted in the presence of metal complex based catalysts proper to urethane reactions.

9. The method according to claim 8, characterised in that said metals are tin and/or bismuth.

10. The method according to one of claims 2 to 9, characterised in that said polycaprolactone polymer of formula IIa 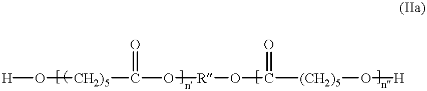
where R″, n′ and n″ have the meaning given hereinbefore, has a molecular weight ranging from 5,000 to 25,000.
